(19) United States
(12) Patent Application Publication
(10) Pub. No.: US 2010/0156066 A1
(43) Pub. Date: Jun. 24, 2010

(54) MOUNTAIN BICYCLE HAVING IMPROVED FRAME GEOMETRY

(76) Inventor: D'Arcy O'Connor, Vancouver (CA)

Correspondence Address: OGILVY RENAULT LLP, 1, Place Ville Marie, SUITE 2500, MONTREAL, QC, H3B 1R1, CA

(21) Appl. No.: 12/638,185

(22) Filed: Dec. 15, 2009

Related U.S. Application Data
(60) Provisional application No. 61/122,448, filed on Dec. 15, 2008.

(51) Int. Cl. B62K 25/04; B62K 25/28

(52) U.S. Cl. 280/283

(57) ABSTRACT

A bicycle frame set with front and rear suspension systems, where a seat point is defined by an intersection of a central axis of the seat post with a top surface of the seat, and a seat tube angle is defined as an acute angle formed between a first line parallel with the ground surface and extending through the seat point and a second line extending from the crank axis to the seat point. An initial seat position is defined when the suspension systems are in an uncompressed state. The frame is configured such that in the initial seat position the second line is located at least about 575 mm from the crank axis and the seat tube angle is at least 75.5 degrees.

### CROSS-REFERENCE TO RELATED APPLICATIONS

This application claims priority on provisional application No. 61/122,448 filed on Dec. 15, 2008, the entire content of which is incorporated by reference herein.

### TECHNICAL FIELD

The present invention generally relates to a full suspension mountain bicycle, more specifically to such a bicycle particularly adapted for cross-country style riding.

### BACKGROUND

A conventional two-wheeled vehicle, such as a bicycle, has normally a relatively rigid frame which provides only minimal absorption of any forces that are transferred to the frame from irregularities in the surface over which the vehicle is being driven. However, as the use of two-wheeled vehicles “off-road”, such as mountain bicycles for example, has increased over recent years, the conventional, generally rigid rear suspensions have proved to be wholly unsatisfactory for reasons of both comfort and performance.

Bicycle suspension systems are generally provided to increase the comfort of the rider and to increase the performance of the bicycle. The comfort of the rider is generally increased by attenuating the vibrations induced by irregularities in the ground surface, rather than transmitting them through the frame of the bicycle to the rider. By maintaining greater contact between the tires and the ground, the suspension also provides the rider with better control for accelerating, braking and cornering.

While bicycles with full suspensions generally provide for a comfortable ride in general, typical full suspension bicycles are usually not designed for providing comfort to the rider during uphill pedaling. During a climb, because the rider's mass is cantilevered a greater distance over the rear wheel, an excess sag of the rear suspension with respect of the front suspension is generally accentuated. As such, the sagged position of the seat during the climb is usually not adequate for efficient pedaling, such that riders often sit on the nose of the seat when pedaling uphill in order to be in a more optimal pedaling position as well as to weigh the front wheel to keep it in contact with the ground. Such a sitting position can be relatively uncomfortable.

Accordingly, improvements are desirable.

### SUMMARY

In accordance with one aspect, there is provided a full suspension bicycle frame set for a bicycle, comprising a frame including at least a seat tube, a top tube, a head tube, a down tube and a bottom bracket fixed to at least one of the seat tube and the down tube, a rear wheel suspension system pivotally attached to the frame for engaging a rear wheel, a front wheel suspension system extending from the frame for engaging a front wheel, and a seat post received in the seat tube and supporting a seat, a seat point being defined at an intersection of a central longitudinal axis of the seat post and a top surface of the seat, a seat tube angle being defined between a first line extending between the seat point and a crank axis of the bottom bracket and a second line extending through the seat point parallel with a surface the bicycle is resting on, an initial seat position being defined with the rear and front wheel suspension systems in an uncompressed state and the second line extending at least about 575 mm above the crank axis, the seat tube angle in the initial seat position being at least 75.5 degrees.

In accordance with another aspect, there is provided a bicycle frame set comprising a frame, a rear wheel suspension system pivotally attached to the frame for engaging a rear wheel, and a front wheel suspension system connected to the frame for engaging a front wheel, the frame defining a crank axis about which pedal cranks of the bicycle rotate and including a seat tube receiving a seat post therein, the seat post supporting a seat, a seat point being defined by an intersection of a central axis of the seat post with a top surface of the seat, a seat tube angle being defined as an acute angle formed between a first line parallel with a ground surface supporting the bicycle and extending through the seat point and a second line extending from the crank axis to the seat point, an initial seat position being defined when the suspension systems are in an uncompressed state, the frame having an initial seat position where the suspension systems are in an uncompressed state, the second line is located at least about 575 mm from the crank axis and the seat tube angle is at least 75.5 degrees.

### BRIEF DESCRIPTION OF THE DRAWINGS

Reference will now be made to the accompanying drawings, showing by way of illustration a particular embodiment of the present invention and in which:

FIG. 1 is a side view of a bicycle according to a particular embodiment of the present invention;

FIG. 2 is a side view of part of a frame of the bicycle of FIG. 1;

FIG. 3 is a side view of part of the frame of the bicycle of FIG. 1, showing a plurality of configurations of the frame throughout a travel of a rear wheel suspension system thereof;

FIG. 4 is a graphical representation of a chain stay lengthening with respect to shock stroke of the bicycle of FIG. 1 relative to a prior bicycle; and

FIG. 5 is a graphical representation of an instantaneous suspension rate with respect to shock stroke of the bicycle of FIG. 1 relative to a prior bicycle.

### DETAILED DESCRIPTION

The full suspension bicycle described herein is generally intended for cross-country style riding where a typical ride might consist of a long uphill climb followed by a long single-track downhill run. This bicycle is thus intended to compliment both the uphill and downhill portion of the ride. However, it is to be understood that the present full suspension bicycle can nonetheless be used for other types and/or styles of riding.

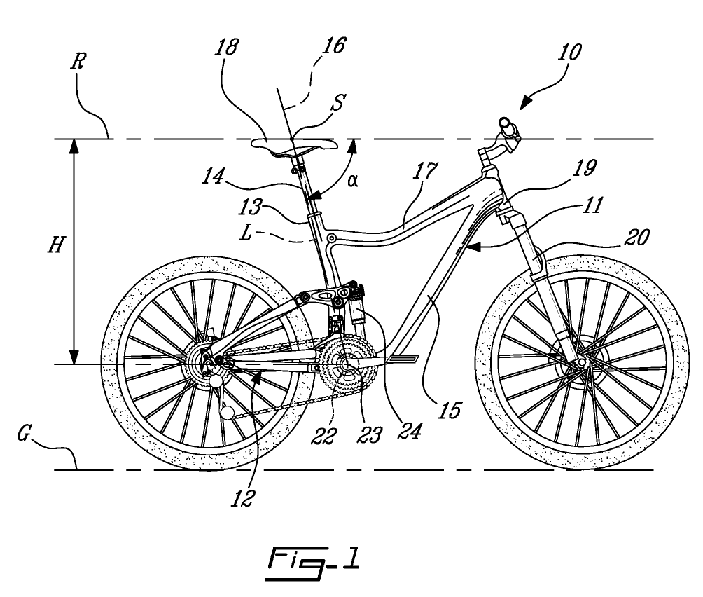

Referring to FIG. 1, the bicycle 10 comprises a rear suspension system linkage assembly 12 and a main frame 11. In a particular embodiment, the main frame 11 is manufactured out of aluminum such as for example a Zn aluminum alloy or a Si—Mg aluminum alloy, or alternately of another adequate material such as, but not limited to, steel or carbon-fiber.

The main frame 11 comprises a seat tube 13, a down tube 15, a top tube 17, a head tube 19, and a bottom bracket 22. The bottom bracket 22 defines a crank axis 23 therethrough, about which the bicycle's pedal cranks rotate. In the embodiment shown, the seat tube 13 rigidly connects the bottom bracket 22 and the top tube 17. In an alternate embodiment (not shown), the seat tube 13 is of “partial length”, i.e. rigidly suspended only from one of the tubes such as the top tube 17, for example.

In an alternate embodiment, the main frame 11 is a single large structure rather than an assembly of distinct tubes, such as a monocoque-type frame section which can be made for example of carbon fiber or sheet metal.

A front suspension system 20 extends from the head tube 19 for receiving a front wheel.

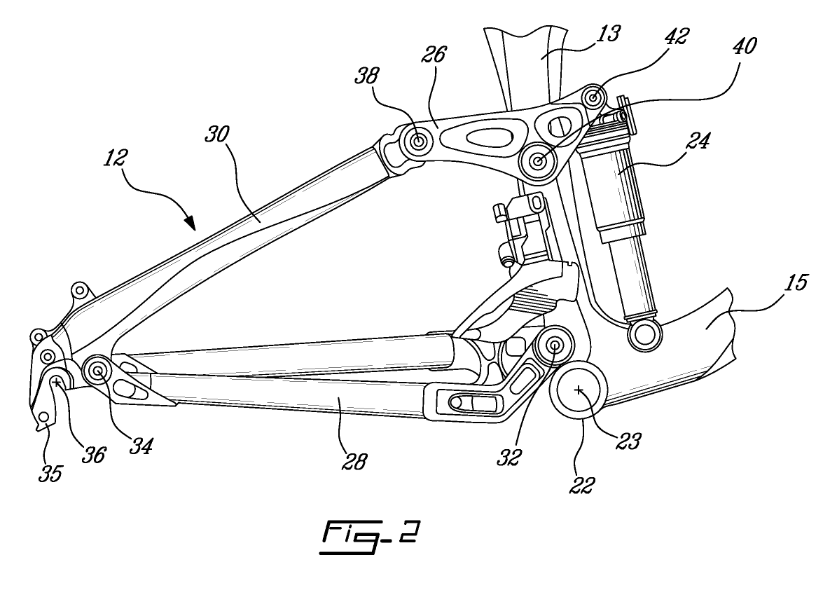

Referring to FIG. 2, a springing and damping mechanism, or shock absorbing member, such as a shock absorber 24, is pivotally attached to the down tube 15. The shock absorber 24 provides a compression resistance force against which the rear suspension system linkage assembly 12 operates.

In an alternate embodiment (not shown), the shock absorber 24 can be attached to the frame 11 through a shock mounting bracket, for example secured within the main frame 10 between the seat tube 13 and the down tube 15, such as shown and described in Applicant's U.S. Pat. No. 7,635,141, filed Mar. 6, 2008 and which is incorporated by reference herein in its entirety. In an alternate embodiment, the shock absorber 24 can alternately be mounted with equal effect elsewhere within the main frame 11 by attaching it to one or more of the other tubes, or outside the main frame 11, such as between an upper link member and the seat tube, for example.

The linkage assembly 12 includes a pair of upper link members 26, a pair of lower link members 28, and a pair of rear stay members 30. The rear wheel of the bicycle is mounted between the pair of rear stay members 30 at dropouts 35 provided at the lower ends thereof. Hence, the rear wheel's axle, and, therefore, the rear wheel's central axis 36, is mounted within the dropouts 35.

The rear ends of the lower link members 28 are pivotally connected to the rear stay members 30 at a rear pivot point 34, and the front ends of the lower link members 28 are pivotally connected to the seat tube 13 of the main frame 11 at a front pivot point 32. The front pivot point 32 is located proximate (above and slightly rearwardly from) the crank axis 23, and the rear pivot point 34 is located proximate (slightly above and forward from) the rear wheel's axis 36. The lower link members 28 are located such that their primary axis (i.e. the axis extending through the pivots 32, 34) is above the rear wheel axis 36 (i.e. the transverse axis extending through the axle of the rear wheel) throughout the full travel of the rear wheel.

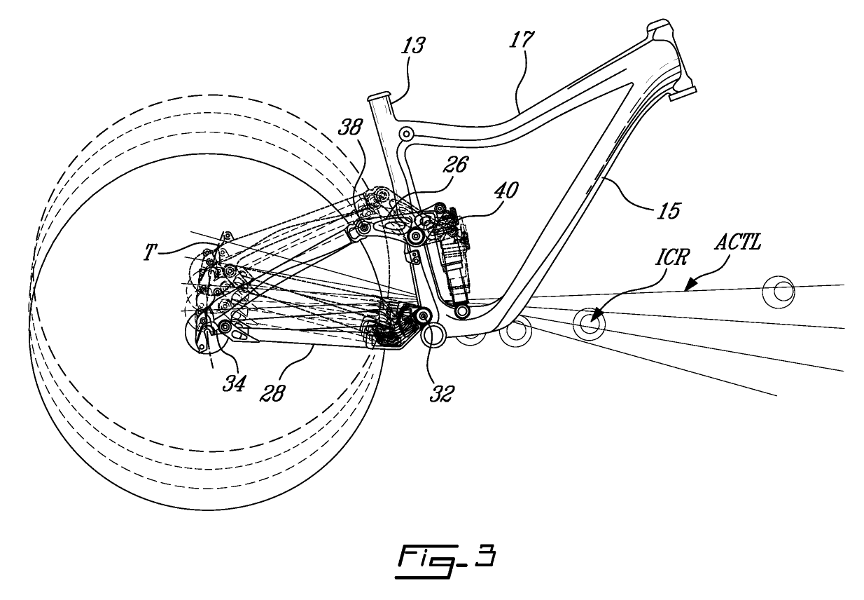

Referring to FIG. 3, the lower link members 28 are also located such that the portion of their primary axis defined between the pivots 32, 34, as well as the instantaneous center of rotation (ICR), remain below the Average Chain Torque Line (ACTL) of the suspension system throughout the travel of the rear wheel. The average chain torque line represents the average of the various chain torque lines for possible gear selections at each given position throughout the wheel travel (i.e. compression level of the suspension system). The chain torque line is defined as a line extending along the tension side of the chain positioned on the chain rings (sprockets) of the bicycle. Thus the chain torque line is substantially tangent to the front and rear chain rings of the bicycle, and represents the line of action of torque transmission between the front pedal crank and the rear sprocket driving the rear wheel. The lower link members 28 moves through the horizontal at the beginning of travel, and cause the ICR to remain slightly below the ACTL at all points of travel. Therefore the ICR wandering from the ACTL during travel is reduced, which reduces pedal feedback.

Referring back to FIG. 2, the rear ends of the upper link members 26 are pivotally connected to the top of the rear stay members 30 at a rear pivot point 38. The upper link members 26 are further pivotally connected, at a pivot point 40 which is located between the ends of the link members, to the seat tube 13 of the main frame 11. The pivot point 40 of the upper link members 26 is substantially higher on the main frame 11 than is the front pivot point 32 of the lower link members 28. Additionally, the front ends of the upper link members 26 are pivotally connected to the top of the shock absorber 24 at a shock pivot point 42.

In the embodiment shown, two link members 26 and two rear stay members 30 are provided, one of each type of member being located on a respective side of the rear wheel and being symmetrical with the other. Two lower link members 28 are also provided, one on each side of the vehicle's rear wheel. The lower link members 28 are not symmetrical but are connected by the same pivots, so that their effective lengths are symmetrical. Alternately, all members can be symmetrical or asymmetrical, or only a single set of members can be used, i.e. located on a single side of the rear wheel.

Although not shown, each of the members (rear stay members 30, upper link members 26, and lower link members 28) which comprises the rear suspension linkage assembly 12 is preferably formed so as to be joined by a yoke to its counterpart member. As such, any potential that might otherwise occur for the counterpart members to twist vis-à-vis each other is thereby reduced significantly if not substantially eliminated.

Referring to FIG. 3, the instantaneous center of rotation (ICR) of the linkage assembly 12 is generally determined by the intersection of a first axis extending through the pivots 38, 40 of the upper link member 26 and of a second axis extending through the pivots 32, 34 of the lower link member 28. Thus, the instantaneous center of rotation (ICR) of the suspension assembly 12 throughout the entire wheel travel remains forward of the crank axis 23, remains below and close to the corresponding Average Chain torque Line (ACTL), and gets progressively lower as the suspension compresses. This practically eliminates any pedal induced suspension bob.

It can also be seen that the travel path T of the rear wheel axis 36 is substantially close to a semi-circular shape, as would be the case with a rear wheel's axis pivoting about a fixed pivot point. A travel path having a substantially circular shape has been found to advantageously eliminate irregular rates of change between the bottom bracket and the rear axle as the rear wheel compresses with at least the geometry of the present bicycle 10. This allows the bicycle to be easier to control during rear wheel maneuvers.

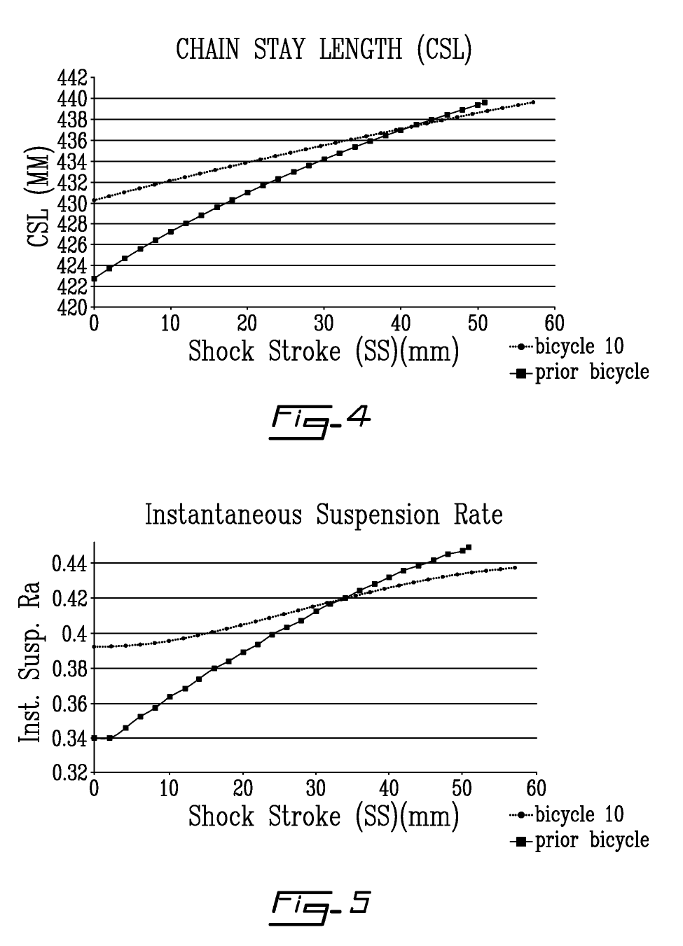

Referring to FIG. 4, in a particular embodiment, the bicycle 10 has 140 mm (5.5 in) of rear wheel travel, and exhibits approximately 8 mm of chain stay lengthening over the course of this rear wheel travel, thus has an overall chain stay lengthening of between about 5% to about 7%, preferably between about 5.7% and about 6.4%, for example about 6% of the rear wheel travel. In comparison, the curve of chain stay lengthening of a prior bicycle is shown, exhibiting approximately 127 mm (5 in) of rear wheel travel and a chain stay lengthening of 16 mm or 12.6% of the vertical rear wheel travel. All bicycle suspensions have some amount of chain stay lengthening. Chain stay lengthening will cause the rear wheel to drive forward, when the rear wheel encounters a bump, the chain stay lengthening thus causing a torque at the rear wheel while the chain is under tension, causing an energy transfer effect. However a reduction in the amount of chain stay lengthening advantageously increases the overall feel of the suspension, making it more active while pedaling, while still maintaining some of the energy transfer effect, as is the case in the bicycle 10.

Referring now to FIG. 5, the instantaneous suspension rate (corresponding to ΔShock Stroke/Δ Vertical Rear wheel Travel) for the bicycle 10 and the prior bicycle is shown. Compared to the prior bicycle, the bicycle 10 has a more level instantaneous suspension rate curve which starts at a higher initial rate and finishes at a lower bottom-out rate. This flatter curve, in combination with a longer stroke shock, allows the suspension a greater degree of movement through suspension travel, thus producing a more “bottomless” feel for the rider. Also, the bicycle advantageously requires less air pressure in the shock absorbers because of the higher initial rate value.

Referring back to FIG. 1, the seat tube 13 of the bicycle 10 receives therein a seat post 14 which supports a seat 18. The seat post 14 has a central axis which is shown at 16. A seat point S is defined at the intersection of the seat post axis 16 and the top surface of the seat 18. The seat tube angle is defined as the acute angle formed between a line R parallel with the ground G (thus a horizontal line when the bicycle is resting on an horizontal surface) extending through the seat point S, and a line L extending from the crank axis 23 of the bottom bracket 22 to the seat point S. An initial seat tube angle α is defined as the seat tube angle when the suspension is in an uncompressed state and with the line R extending through the seat point S and parallel with the ground G (thus horizontal when the bicycle is resting on an horizontal surface) located at a minimum distance H from the crank axis 23 of the bottom bracket 22. In a particular embodiment, the minimum distance H between the line R and the crank axis 23 of the bottom bracket 22 is at least about 575 mm, and at most about 820 mm, when the suspension is in an uncompressed state.

As mentioned above, bicycles with full suspensions generally exhibit a sag difference between the front and rear suspension, which is generally accentuated during a climb. For example, when pedaling on flat ground, a suspension bicycle having an initial seat tube angle of 74.5 degrees or less will sag to a seat tube angle of about 73 degrees or less, which is a very uncomfortable position to ride in; when pedaling on an incline, this sag angle is increased due to the cantilever effect and may sag below 72 degrees. In a particular embodiment, the bicycle 10 includes wheels having a diameter of between 26 and 29 inches and has a suspension travel from 0 to 180 mm, and the seat tube 13 of the bicycle 10 has an initial seat tube angle α of at least 75.5 degrees, and preferably between 75.5 degrees and 78 degrees, such as to compensate for the increased suspension sag during climbing. In a particular embodiment, the initial seat tube angle α is 76 degrees.

The more pronounced (i.e. vertically upright or steep) initial seat tube a of the bicycle, in combination with the geometry of the linkage assembly 12, allows for the seat tube 13 to sag to a sagged position having an angle more adequate for pedaling during a climb, for example 74.5 degrees, thus allowing the rider to remain correctly seated on the seat 18 during a climb while being in a comfortable position for pedaling. In a particular embodiment, this sagged position corresponds to about 25% of compression of the rear wheel suspension system. The seat tube angle during the sagged climb position thus approaches the 75 degree seat tube angle that can be found in rigid road bicycles which are devoid of rear suspensions, thus placing the rider's hips in the optimal position over the bottom bracket 22 to maximize the power output from the legs and body when climbing while remaining comfortably seated on the seat 18.

During the descending portion of the ride, the rider usually stands up, i.e. is not seated on the seat 18, and as such the increased initial seat tube angle α does not influence the rider's position during downhill riding. In a particular embodiment, the front-center measurement of the bicycle 10 is increased when compared to prior full suspension bicycles while the length of the top tube 17 is reduced, thus allowing for maintaining an optimal wheelbase length.

The embodiments of the invention described above are intended to be exemplary. Those skilled in the art will therefore appreciate that the foregoing description is illustrative only, and that various alternate configurations and modifications can be devised without departing from the spirit of the present invention. Accordingly, the present invention is intended to embrace all such alternate configurations, modifications and variances which fall within the scope of the appended claims.

1. A full suspension bicycle frame set for a bicycle, comprising a frame including at least a seat tube, a top tube, a head tube, a down tube and a bottom bracket fixed to at least one of the seat tube and the down tube, a rear wheel suspension system pivotally attached to the frame for engaging a rear wheel, a front wheel suspension system extending from the frame for engaging a front wheel, and a seat post received in the seat tube and supporting a seat, a seat point being defined at an intersection of a central longitudinal axis of the seat post and a top surface of the seat, a seat tube angle being defined between a first line extending between the seat point and a crank axis of the bottom bracket and a second line extending through the seat point parallel with a surface the bicycle is resting on, an initial seat position being defined with the rear and front wheel suspension systems in an uncompressed state and the second line extending at least about 575 mm above the crank axis, the seat tube angle in the initial seat position being at least 75.5 degrees.

2. The bicycle frame set according to claim 1, wherein a sagged position of the rear wheel suspension system corresponds to about 25% of compression of the rear wheel suspension system, and wherein the seat tube angle is at least 74.5 degrees in said sagged position.

3. The bicycle frame set according to claim 1, wherein the seat tube angle with the seat in the initial seat position is between 75.5 and 78 degrees.

4. The bicycle frame set according to claim 3, wherein the seat tube angle with the seat in the initial seat position is 76 degrees.

5. The bicycle frame set according to claim 1, wherein the initial seat position is defined with the second line extending at most about 820 mm above the crank axis.

6. The bicycle frame set according to claim 1, wherein the rear wheel suspension system comprises an upper link pivotally attached to the frame at a first pivot point, a rear stay member having an upper end pivotally attached to the upper link at a second pivot point and a lower end having a dropout receiving a rear wheel axle of the bicycle, a lower link pivotally attached to the frame at a third pivot point located on said frame at a lower vertical elevation than the first pivot point, the lower link being pivotally attached to the rear stay member at a fourth pivot point located on said rear stay member below said upper end thereof and above a rear wheel mounting axis of the dropout, and a shock absorber having a first end pivotally connected to the upper link and a second end pivotally connected to the frame.

7. The bicycle frame set according to claim 6, wherein an instantaneous center of rotation is defined at an intersection between an upper axis extending through the first and second pivots and a lower axis extending through the third and fourth pivots, and wherein, throughout a travel distance of the shock absorber, the instantaneous center of rotation remains below an average chain torque line, the lower axis remains above an axle axis of the dropout, and a portion of the lower axis remains on a same side of the average chain torque line throughout a travel of the rear wheel suspension system.

8. The bicycle frame set according to claim 1, wherein a chain stay lengthening of the frame set over a complete travel of the rear wheel suspension system is less than 12.6% of a vertical travel distance of the rear wheel.

9. The bicycle frame set according to claim 8, wherein the chain stay lengthening is about 6.4% of the vertical travel distance of the rear wheel.

10. A bicycle frame set comprising a frame, a rear wheel suspension system pivotally attached to the frame for engaging a rear wheel, and a front wheel suspension system connected to the frame for engaging a front wheel, the frame defining a crank axis about which pedal cranks of the bicycle rotate and including a seat tube receiving a seat post therein, the seat post supporting a seat, a seat point being defined by an intersection of a central axis of the seat post with a top surface of the seat, a seat tube angle being defined as an acute angle formed between a first line parallel with a ground surface supporting the bicycle and extending through the seat point and a second line extending from the crank axis to the seat point, the frame having an initial seat position where the suspension systems are in an uncompressed state, the second line is located at least about 575 mm from the crank axis and the seat tube angle is at least 75.5 degrees.

11. The bicycle frame set according to claim 10, wherein a sagged position of the rear wheel suspension system corresponds to about 25% of compression, and wherein the seat tube angle is at least 74.5 degrees in the sagged position.

12. The bicycle frame set according to claim 10, wherein the seat tube angle in the initial seat position is between 75.5 and 78 degrees.

13. The bicycle frame set according to claim 12, wherein the seat tube angle in the initial seat position is 76 degrees.

14. The bicycle frame set according to claim 10, wherein the initial seat position is defined with the second line extending at most about 820 mm above the crank axis

15. The bicycle frame set according to claim 10, wherein the rear wheel suspension system comprises an upper link pivotally attached to the frame at a first pivot point, a rear stay member having an upper end pivotally attached to the upper link at a second pivot point and a lower end having a dropout receiving a rear wheel axle of the rear wheel, a lower link pivotally attached to the frame at a third pivot point located on the frame at a lower vertical elevation than the first pivot point, the lower link being pivotally attached to the rear stay member at a fourth pivot point located on the rear stay member below the upper end thereof and above a rear wheel mounting axis of the dropout, and a shock absorber having a first end pivotally connected to the upper link and a second end pivotally connected to the frame.

16. The bicycle frame set according to claim 15, wherein an instantaneous center of rotation is defined at an intersection between an upper axis extending through the first and second pivots and a lower axis extending through the third and fourth pivots, and wherein, throughout a travel distance of the shock absorber, the instantaneous center of rotation remains below an average chain torque line, the lower axis remains above an axle axis of the dropout, and a portion of the lower axis remains on a same side of the average chain torque line throughout a travel of the rear wheel suspension system.

17. The bicycle frame set according to claim 10, wherein a chain stay lengthening of the frame set over a complete travel of the rear wheel suspension system is less than 12.6% of a vertical travel distance of the rear wheel.

18. The bicycle frame set according to claim 17, wherein the chain stay lengthening is about 6.4% of the vertical travel distance of the rear wheel.
